(19) United States
(12) Patent Application Publication
(10) Pub. No.: US 2014/0298275 A1
(43) Pub. Date: Oct. 2, 2014

(54) METHOD FOR RECOGNIZING INPUT GESTURES

(71) Applicant: Sergey POPOV, Beer Sheva (IL)

(72) Inventor: Sergey Popov, Beer-Sheva (IL)

(21) Appl. No.: 14/353,510

(22) PCT Filed: Oct. 22, 2012
(86) PCT No.: PCT/IL2012/050415

§ 371 Date: Apr. 23, 2014

(30) Foreign Application Priority Data
Oct. 23, 2011 (IL) 215741

(51) Int. Cl. G06F 3/01; G06F 3/0481

(52) U.S. Cl. CPC G06F 3/017; G06F 3/0481
USPC 715/863

(57) ABSTRACT

The present invention relates to methods, systems, and computer program products for recognizing input point gestures. The system recognizes a position of a cursor finger 17 on a multi-touch X-Y input surface 18 of a touch-sensor pad 19 and defines a position of a parting line 21 which is a virtual line intersecting the input surface 18 at cursor touch point 20 along one of X or Y axes and operatively dividing the input surface 18 into two functionally different button zones 22, 23. The position of the parting line 21 is simultaneously changing with the position of the cursor point 20. The specified contacts of the additional fingers 26, 27 to these button zones 22, 23 the system recognizes as control gestures (e.g., single tap, doable tap, drag, scroll and others).

### FIELD OF INVENTION

The present invention is generally related to coordinate based data input devices and more particularly related to a method and apparatus for emulating a supplemental mouse button, for example, a right mouse button or other non-primary feature selection button, in a touch-type coordinate based data input device.

### BACKGROUND AND OBJECTS OF THE INVENTION

Several methods and devices are known in the art for facilitating the movement of a cursor to a point on the display of a computer or the like. Such methods and devices are useful in assisting electronic system users in selecting text, graphics, or menus for subsequent manipulation.

Touch pads relate to coordinate based input devices designed for selecting different features related to or useful to a coordinate selected.

Systems capable of emulating relative coordinate device mouse button commands have been disclosed in U.S. Pat. No 7,911,456 to Gillespie teaches a system for simulating a mouse buttons by permanent dividing a touch pad surface into three functional zones, corresponding to the left, middle, and right mouse buttons, or into two functional zones: a main area simulating the left mouse button, and a small corner area simulating the right mouse button. Furthermore, in U.S. Pat. No. 7,911,456 to Gillespie is emphasized that it is preferable for the zones to correspond to clearly marked regions on the pad surface. The concept described in U.S. Pat. No 7,911,456 to Gillespie demands very complicated algorithm for gestures recognizing and changes in users' habits of work.

### SUMMARY OF THE INVENTION

The present invention with a multi-touch X-Y input device provides cursor or pointer position data and left and right mouse buttons emulation with ergonomic and simple finger gestures for base control functions, similar to control gestures with regular mouse. The present invention discloses a method for providing base mouse and mouse button function emulation input to a program capable of receiving input from a mouse.

The invention relates, in one embodiment, to a computer implemented gestural method for processing touch inputs. The method includes detecting the occurrence of a cursor gesture made by a cursor finger on the input surface during a cursor session when a cursor finger touches the input surface in a cursor touch point; generating a cursor signal indicating the occurrence of said cursor gesture defining a position of a cursor on a display and a position of a parting line, which is a virtual line intersecting the input surface at the cursor touch point along one of X or Y axes and operatively dividing the input surface into two functionally different button zones; wherein the movement of the cursor touch point within the input surface simultaneously changes the position of the cursor on the display and the position of the parting line within the input surface.

The invention relates, in another embodiment to a method in which the parting line divides the input surface along Y axis into a left button zone and a right button zone, so that a functional touching of the left zone or right zones during the cursor session are resolved into left or right mouse button events correspondently.

The invention relates, in another embodiment to a gestural method in which a left button single tap gesture, a left button double tap gesture or a right button single tap gesture are recognized in response to one, double finger tapping on the left or right button zone correspondently.

The invention relates, in another embodiment to a gestural method in which the group of gestures is recognized when the cursor finger and the cursor remain stationary and the left button finger being in touch with left button zone moves in specified manner, wherein the specified manner of the left button finger movement for initiation scrolling, zooming and rotating gestures is the movement along the Y axis, along X axis and in round manner correspondently.

The invention relates, in another embodiment to a gestural method in which together with the cursor finger at least one additional finger rests on the input surface touching the input surface at a pressure lesser than a threshold, wherein the system recognizes the cursor gesturer and detects the idle touch of the additional finger on the input surface which do not initiate any control gesture signal.

The invention relates, in another embodiment to a gestural method in which a left button single tap gesture, a left button double tap gesture or a right button single tap gesture are recognized in response to one, double finger tapping, producing a short impact pressure greater than a threshold on the left or right button zone correspondently.

The invention relates, in another embodiment to a gestural method in which the group of gestures is recognized when the cursor finger and the cursor remains stationary and the additional finger, defined as a left button finger being in touch with the left button zone, with a pressure lesser than a threshold, moves for initiation scrolling, zooming and rotating gestures along the Y axis, along X axis and in round manner correspondently.

The invention relates, in another embodiment to a gestural method in which when three fingers touch the input surface the finger located between lateral fingers is recognized as the cursor finger, for example if the input surface is touched by forefinger, middle finger, and third finger; the middle finger is recognized as the cursor finger, and the additional fingers: the forefinger and the third finger are recognized as a left button finger and a right button finger correspondently.

### BRIEF DESCRIPTION OF THE DRAWINGS

FIG. 1 is a block diagram of a computer system, in accordance with the present invention.

FIG. 2 illustrates a view of an input region of a multi-touch input surface depicting: a touch point of a cursor finger recognized as a cursor gesture; and a parting line dividing X-Y input surface into a left button zone and a right button zone.

FIG. 3 illustrates a view of an input region of a multi-touch input surface depicting a multi finger touch and presence on the X-Y input surface.

### DETAILED DESCRIPTION OF THE INVENTION

The invention generally pertains to gestures and methods of implementing gestures with touch sensitive devices. Examples of touch sensitive devices include touch screens and touch-sensor pads.

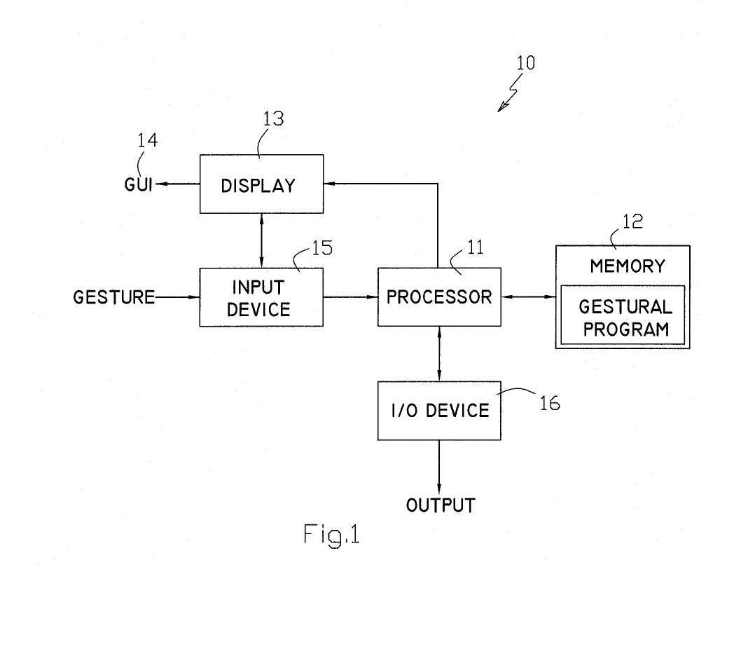

Some aspects of the invention are discussed below with reference to FIGS. 1-3. However, those of ordinary skill in the art will realize that the following description of the present invention is illustrative only and not in any way limiting. Other embodiments of the invention will readily suggest themselves to such skilled persons.

FIG. 1 illustrates an example computer system architecture 10 that facilitates recognizing multiple input point gestures. The computer system 10 includes a processor 11 operatively coupled to a memory block 12. The computer system 10 also includes a display device 13 that is operatively coupled to the processor 11. The display device 13 is generally configured to display a graphical user interface (GUI) 14 that provides an easy to use interface between a user of the computer system and the operating system or application running thereon. The computer system 10 also includes an input device 15 that is operatively coupled to the processor 11. The input device 15 is configured to transfer data from the outside world into the computer system 10. The input device 15 may for example be used to perform tracking and to make selections with respect to the GUI 14 on the display 13. The input device 15 may also be used to issue commands in the computer system 10. The input device 15 may include a touch sensing device configured to receive input from a user's touch and to send this information to the processor 11. By way of example, the touch-sensing device may correspond to a touchpad or a touch screen. In many cases, the touch-sensing device recognizes touches, as well as the position and magnitude of touches on a touch sensitive surface. The touch sensing means reports the touches to the processor 11 and the processor 11 interprets the touches in accordance with its programming. For example, the processor 11 may initiate a task in accordance with a particular touch. The touch sensing device may be based on sensing technologies including but not limited to capacitive sensing, resistive sensing, surface acoustic wave sensing, pressure sensing, optical sensing, and/or the like.

The computer system 10 also includes capabilities for coupling to one or more I/O devices 16 like keyboards, printers, scanners, and/or others.

In accordance with one embodiment of the present invention, the computer system 10 is designed to recognize cursor gestures FIG. 2 applied by a cursor finger 17 on the X-Y input surface 18 of a touchpad 19, which provides X and Y position information and the cursor motion direction signals to the computer system 10. As an arbitrary convention herein, one set of position signals will be referred to as being oriented in the “X axis” direction and the another set of position signals will be referred to as being oriented in the “Y axis”. The time the cursor finger stays in touch with the input surface in a cursor touch point 20 will be referred to as a cursor session. During the cursor session there is generating a cursor signal indicating the occurrence of said cursor gesture defining a position of a cursor on a display and a position of a parting line 21, which is a virtual line intersecting the input surface at said cursor touch point along one of X or Y axes and operatively dividing the input surface 18 into two functionally different button zones 22, 23; wherein the movement of said cursor touch point 20 within said input surface 18 from position A to position B simultaneously changes the position of the cursor on the display and the position of said parting line 21′ within said input surface. It is preferable that the first finger that touches the input surface 18 is defined as a cursor finger 17 and said parting line 21 divides said input surface along Y axis into a left button zone (LBZ) 24 and a right button zone (RBZ) 25, so that a functional touching of said left LBZ or RBZ during said cursor session are resolved into left or right mouse button events correspondently.

So, to simulate a left button single click user applies the left finger single tap within left button zone 24 FIG. 2 by the left button finger 26 which is the left of the cursor finger 17, producing the left button single tap gesture.

To simulate a left button double click user applies the left finger double tap within left button zone 24 FIG. 2 by the left button finger 26 which is the left of the cursor finger 17, producing the left button double tap gesture.

To simulate a right button single click user applies the right finger single tap within right button zone 25 FIG. 2 by the right button finger 27 which is the right of the cursor finger 17, producing the right button single tap gesture.

Thus, to generate the left button single tap gesture, the left button double tap gesture and the right button single tap gesture according the aspect of the invention illustrated on FIG. 2 the left and right button fingers 26, 27 contact to input surface 18 only at the moments of taping.

To generate a drug gesture the cursor finger 17 slides within input surface 18 bringing the cursor to an object destined to be drag and points the object; left button finger 26 single-taps within left button zone 24 selecting the object and continues to be in touch with input surface 18, holding a virtual left button down. User moves the both cursor finger 17 and left button fingers 26, which are in contact with input surface 18, upon input surface 18, drugging the object around the display 13 to the place of destination, where one of left button finger 26 or cursor finger 17 or both of them are lifted and the drag gesture ends.

The generation of the left button single tap gesture, the left button double tap gesture, the right button single tap gesture and the drug gesture according the aspect of the invention illustrated on FIG. 2 are analogous to the clicking of the mouse button on a conventional mouse, and the concept of dragging objects is familiar to all mouse users.

In another embodiment the group of gestures is recognized when cursor finger 17 and said cursor remain stationary and left button finger 26 being in touch (not shown) with left button zone 24 moves in specified manner, wherein said specified manner of left button finger 26 movement for initiation scrolling, zooming and rotating gestures is the movement along the Y axis, along X axis and in round manner correspondently.

According above, drug gesture, scrolling, zooming and rotating gestures are two touch point gestures demand a long contact of two fingers with input surface 18 and to end the gesture it is enough to lift on of the fingers, wherein the last finger that remains in touch with input surface 18 is recognized as the cursor finger.

In another embodiment besides simple X and Y position information, the sensor technology of the present invention also provides Z finger pressure information. This additional dimension of information allows the method of more ergonomic interaction with the input device. The sense system of the present invention depends on a transducer device capable of providing X, Y position and Z pressure information regarding the object contacting the transducer.

Several parameters are used for gestures recognition according this embodiment. Impact touch is the threshold minimum pressure to detect a tapping finger. Idle touch is a finger touch with the pressure on the input surface enough to be detected as the presence of the contact, but lesser than threshold.

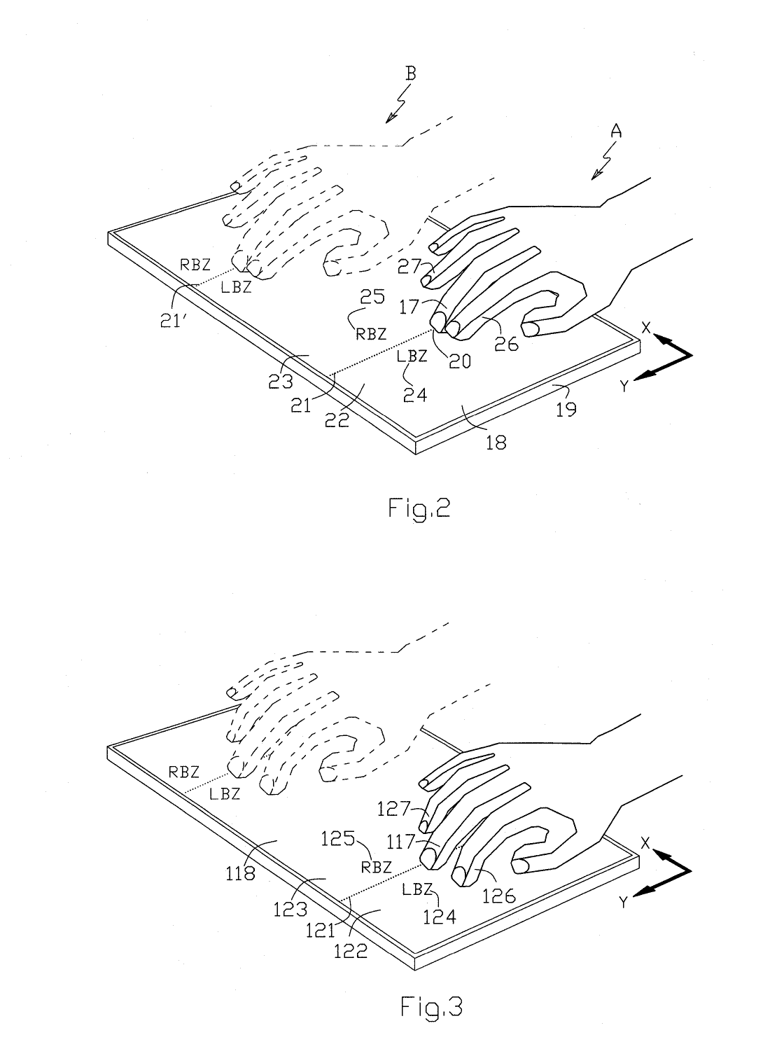

According this embodiment FIG. 3 at least one additional finger rests on input surface 118 along with cursor finger 117. But this additional finger touches input surface 118 at a pressure lesser than a threshold. The system recognizes cursor gesturer and detects the idle touch of the additional finger on input surface 118 which don't initiate any control gesture signals. FIG. 3 illustrates two additional fingers 126, 127 touching input surface 118 along with cursor finger 117 so that the forefinger 126 is the left button finger touching left button zone 124, the middle finger 117 is the cursor finger and the third finger 127 is the right button finger touching right button zone 125.

In this embodiment FIG. 3 a left button single tap gesture that simulates a left button single click is recognized in response to: lifting of forefinger 126, above left button zone 124; forefinger 126 single tapping, producing a short impact pressure greater than a threshold; and retaining forefinger 126 in the idle touch on input surface 118.

In this embodiment FIG. 3 a left button double tap gesture that simulates a left button double click is recognized in response to: the first lifting of forefinger 126 above left button zone 124; first forefinger 126 single tapping, producing a short impact pressure greater than a threshold; second lifting of forefinger 126 above left button zone 124; second forefinger 126 single tapping, producing a short impact pressure greater than a threshold; and retaining forefinger 126 in the idle touch on input surface 118.

In this embodiment FIG. 3 a right button single tap gesture that simulates a right button single click is recognized in response to: lifting of third finger 127, above right button zone 125; third finger 127 single tapping, producing a short impact pressure greater than a threshold; and retaining third finger 127 in the idle touch on input surface 118.

To generate drug gesture in this embodiment FIG. 3 the cursor finger 117 and forefinger 126 slide within input surface 118 bringing the cursor to an object destined to be drag and point the object; forefinger 126 single-taps within left button zone 124 at a pressure greater than a threshold, selecting the object and continues to be in idle touch with input surface 118, holding a virtual left button down; both cursor finger 117 and forefinger 126 slides upon input surface 118 drugging the object around the display to the place of destination where one of forefinger 126 or cursor finger 117 or both of them are lifted and the drag gesture ends.

In another embodiment the group of gestures is recognized when cursor finger 117 and the cursor remain stationary and forefinger 126 being in touch with left button zone 124, with a pressure lesser than a threshold, moves in specified manner, wherein said specified manner of forefinger 126 movement for initiation scrolling, zooming and rotating gestures is the movement along the Y axis, along X axis and in round manner correspondently.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

1. A method for recognizing input gestures made on a multi-touch X-Y input surface of a touch-sensor pad in a touch-sensing system including a display, processor and system memory, the method includes the steps of:
detecting the occurrence of a cursor gesture made by a cursor finger on the input surface during a cursor session when a cursor finger touches the input surface in a cursor touch point;
generating a cursor signal indicating the occurrence of said cursor gesture defining a position of a cursor on a display and a position of a parting line, which is a virtual line intersecting the input surface at said cursor touch point along one of X or Y axes and operatively dividing the input surface into two functionally different button zones; wherein the movement of said cursor touch point within said input surface simultaneously changes the position of the cursor on the display and the position of said parting line within said input surface.

2. The method of claim 1, wherein the first finger that touches the input surface is defined as a cursor finger.

3. The method of claim 1, wherein said parting line divides said input surface along Y axis into a left button zone and a right button zone, so that a functional touching of said left zone or right zones during said cursor session are resolved into left or right mouse button events correspondently.

4. The method of claim 3, wherein a left button single tap gesture simulating a left button single click is recognized in response on the left finger single tap within left button zone.

5. The method of claim 3, wherein a left button double tap gesture simulating a left button double click is recognized in response on the left finger double tap within left button zone.

6. The method of claim 3, wherein a right button single tap gesture simulating a right button single click is recognized in response on the right finger single tap within right button zone.

7. The method of claim 3, wherein the touch-sensing system recognizes a drag gesture when:
the cursor finger slides within said input surface bringing the cursor to an object destined to be drag and points the object;
another—a left button finger single-taps within said left button zone selecting the object and continues to be in touch with said input surface, holding a virtual left button down;
both said cursor finger and left button fingers slides upon said input surface drugging the object around the display to the place of destination where one of said left button finger or cursor finger or both of them are lifted and the drag gesture ends.

8. The method of claim 3, wherein the group of gestures is recognized when said cursor finger and said cursor remain stationary and said left button finger being in touch with left button zone moves in specified manner.

9. The method of claim 8, wherein said specified manner of said left button finger movement for initiation scrolling, zooming and rotating gestures is the movement along the Y axis, along X axis and in round manner correspondently.

10. The method of claim 1, wherein the last finger that remains in touch with said input surface is recognized as a cursor finger.

11. The method of claim 3, wherein:
along with said cursor finger at least one additional finger rests on said input surface touching said input surface at a pressure lesser than a threshold;
the system recognizes said cursor gesturer and detects the idle touch of the additional finger of said input surface which don't initiate any control gesture signal.

12. The method of claim 11, wherein a left button single tap gesture simulating a left button single click is recognized in response to:
lifting of said additional finger, defined as a left button finger, above said input surface;
left button finger single tapping, producing a short impact pressure greater than a threshold;
retaining said left button finger in said idle touch on said input surface.

13. The method of claim 11, wherein a left button double tap gesture simulating a left button double click is recognized in response to:
first lifting of said additional finger, defined as a left button finger, above said input surface;
first left button finger single tapping, producing a short impact pressure greater than a threshold;
second lifting said left button finger above said input surface;
second left button finger single tapping, producing a short impact pressure greater than a threshold;
retaining said left button finger in said idle touch on said input surface.

14. The method of claim 11, wherein a right button single tap gesture simulating a right button single click is recognized in response to:
lifting of additional finger, defined as a right button finger above said input surface;
right button finger single tapping, producing a short impact pressure greater than a threshold;
retaining said right button finger in said idle touch on said input surface.

15. The method of claim 11, wherein the touch-sensing system recognizes a drag gesture when:
the cursor finger and the additional finger slide within said input surface bringing the cursor to an object destined to be drag and points the object;
said additional finger, defined as a left button finger single-taps within said left button zone at a pressure greater than a threshold, selecting the object and continues to be in idle touch with said input surface, holding a virtual left button down;
both said cursor finger and left button fingers slides upon said input surface drugging the object around the display to the place of destination where one of said left button finger or cursor finger or both of them are lifted and the drag gesture ends.

16. The method of claim 11, wherein the group of gestures is recognized when said cursor finger and said cursor remains stationary and said additional finger, defined as a left button finger being in touch with left button zone, with a pressure lesser than a threshold, moves in specified manner.

17. The method of claim 16, wherein said specified manner of said left button finger movement for initiation scrolling, zooming and rotating gestures is the movement along the Y axis, along X axis and in round manner correspondently.

18. The method of claim 11, when three fingers touch said input surface the finger located between lateral fingers is recognized as said cursor finger, for example if said input surface is touched by forefinger, middle finger, and third finger; the middle finger is recognized as said cursor finger, and the additional fingers: the forefinger and the third finger are recognized as a left button finger and a right button finger correspondently.
